(19) United States
(12) Patent Application Publication
(10) Pub. No.: US 2024/0187278 A1
(43) Pub. Date: Jun. 6, 2024

(54) INFORMATION PROCESSOR, METHOD FOR PROCESSING INFORMATION, AND NON-TRANSITORY COMPUTER-READABLE STORAGE MEDIUM STORING INFORMATION PROCESSING PROGRAM

(71) Applicant: TOYOTA JIDOSHA KABUSHIKI KAISHA, Toyota-shi (JP)

(72) Inventors: Ryosuke SAKAI, Okazaki-shi (JP); Kohtaroh HARA, Nagoya-shi (JP)

(73) Assignee: TOYOTA JIDOSHA KABUSHIKI KAISHA, Toyota-shi (JP)

(21) Appl. No.: 18/387,548

(22) Filed: Nov. 7, 2023

(30) Foreign Application Priority Data
Dec. 1, 2022 (JP) 2022-192903

(51) Int. Cl. H04L 12/40; H04L 47/36

(52) U.S. Cl. CPC H04L 12/4013; H04L 47/36

(57) ABSTRACT

Processing circuitry extracts, from multiple types of data frames, a specific data frame having a data length that can be shortened based on data frame type. The processing circuitry reconstructs the specific data frame as a new data frame having a shorter data length by updating the data length code included in the specific data frame to indicate the shorter data length.

### BACKGROUND

### 1. Field

The following description relates to an information processor, a method for processing information, and a non-transitory computer-readable storage medium that stores an information processing program.

### 2. Description of Related Art

Japanese Laid-Open Patent Publication No. 2017-073709 describes a communication system including a plurality of devices connected by communication buses. The communication system includes a relay device that relays data. The relay device is connected to a plurality of communication buses. The relay device receives and transmits data through a communication protocol in compliance with Ethernet standards.

When a relay device is connected to multiple communication buses like in the communication system described in the above patent publication, an increase in the amount of data transferred through each communication bus may cause latency in relay of the data by the relay device. Accordingly, there is a need for designing a data frame for a communication system that allows for more efficient communication.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processor includes processing circuitry. The processing circuitry is configured to extract, from multiple types of data frames transmitted through a communication bus, a specific data frame having a data length that can be shortened based on data frame type. Each of the data frames includes a data field and a data length code indicating a data length of the data field. The processing circuitry is configured to reconstruct the specific data frame as a new data frame having a shorter data length by updating the data length code included in the specific data frame to indicate the shorter data length.

In another general aspect, a method for processing information includes extracting, from multiple types of data frames transmitted through a communication bus, a specific data frame having a data length that can be shortened based on data frame type with a computer. Each of the data frames includes a data field and a data length code indicating a data length of the data field. The method further includes reconstructing the specific data frame as a new data frame having a shorter data length by updating the data length code included in the specific data frame to indicate the shorter data length with the computer.

In another general aspect, a non-transitory computer-readable storage medium storing an information processing program, where the information processing program causes a computer to extract, from multiple types of data frames transmitted through a communication bus, a specific data frame having a data length that can be shortened based on data frame type. Each of the data frames including a data field and a data length code indicating a data length of the data field. Further, the information processing program causes a computer to reconstruct the specific data frame as a new data frame having a shorter data length by updating the data length code included in the specific data frame to indicate the shorter data length.

Other features and aspects will be apparent from the following detailed description, the drawings, and the claims.

### BRIEF DESCRIPTION OF THE DRAWINGS

FIG. 1 is a schematic diagram showing a communication system of a vehicle.

FIG. 2 is a diagram showing the structure of a data frame.

FIG. 3 is a schematic diagram showing an information processing system of a vehicle.

FIG. 4 is a flowchart illustrating processing series of a method for processing information.

FIG. 5 is a flowchart illustrating a process for adjusting the number of data frames transmitted in each cycle.

FIG. 6 is a flowchart illustrating a process for extracting a specific data frame.

FIG. 7 is a flowchart illustrating a process for updating a data length code.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### Embodiment

An information processor, a method for processing information, and a non-transitory computer-readable storage medium that stores an information processing program in accordance with an embodiment will now be described with reference to the drawings.

### Communication System of Vehicle

A communication system of a vehicle is described below.

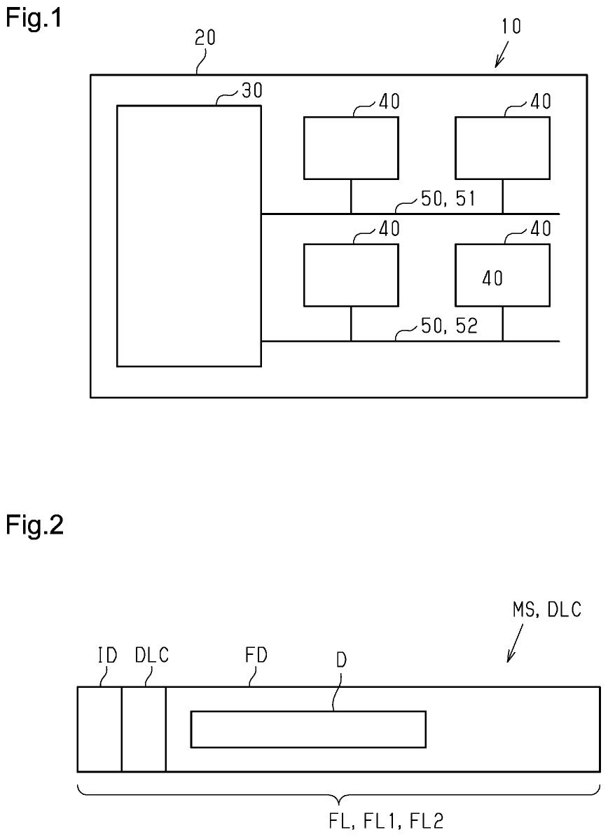

As shown in FIG. 1, a vehicle 10 includes a communication system 20. The communication system 20 includes a relay 30 and controllers 40. The relay 30 is connected to each of the controllers 40 by a communication bus 50. In the communication system 20, a message MS is transmitted in accordance with a Controller Area Network (CAN) Flexible Data-Rate (FDR) protocol.

In the present embodiment, two controllers 40 are connected to the relay 30 by a first bus 51. Further, two other controllers 40 are connected to the relay 30 by a second bus 52.

In an example, the controller 40 controls an actuator installed in the vehicle 10. In another example, the controller 40 outputs an actuation request to another controller 40 based on a detection value of a sensor (not shown).

More specifically, one of the controllers 40 controls an engine of the vehicle 10. Further, one of the controllers 40 controls, for example, a brake of the vehicle 10. Furthermore, one the controllers 40 is an advanced safety electronic control unit (ECU) that outputs an actuation request related to acceleration/deceleration of the vehicle 10.

Each controller 40 transmits a message MS, configured by a predetermined data frame FL, through the communication bus 50 to another controller 40 in predetermined cycles. The controller 40 transmitting the message MS and the controller 40 receiving the message MS may be connected to different communication buses 50. In this case, the relay 30 relays the message MS so that the recipient controller 40 receives the message MS through its communication bus 50.

The relay 30 relays a message MS transmitted through the communication buses 50. For example, the controller 40 connected to the first bus 51 transmits a message MS to the controller 40 connected to the second bus 52. In this case, the relay 30 receives the message MS through the first bus 51 and transmits the message MS through the second bus 52.

As shown in FIG. 2, a data frame FL includes an identification number ID, a data length code DLC, and a data field FD. The data field FD includes data D, which is the main body of the message MS. The data length code DLC determines a data length, or the size of the data field FD. The data length code DLC is a value indicating the data length, or the size of the data field FD. The data length code DLC is an integer in a range from 0 to 15. The number of data bytes in the data field FD, indicating the size of the data field FD, is an integer in a range of from 0 to 8, or one selected from 12, 16, 20, 24, 32, 48, and 64. As the value of the data length code DLC increases, the number of data bytes in the data field FD increases. In an example, when the data length code DLC is 12, the data bytes in the data field FD, or the data length, is 24 bytes. In another example, when the data length code DLC is 13, the data bytes in the data field FD, or the data length, is 32 bytes. The identification number ID indicates the type of the data D incorporated in the data field FD, and the recipient controller 40. Also, the identification number ID is used for determining the order of priority in adjusting communication.

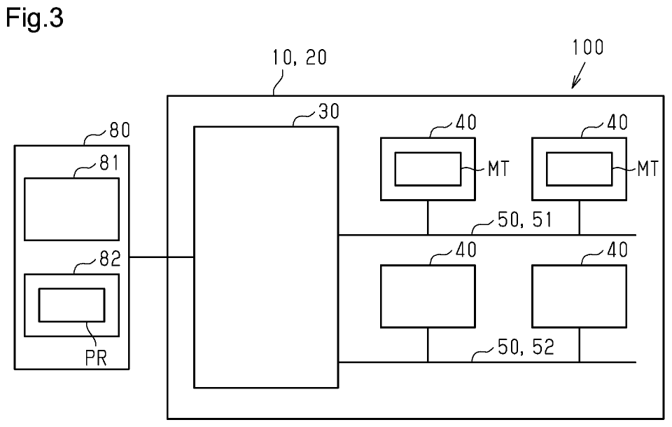

As shown in FIG. 3, each controller 40 stores a message table MT that indicates cycles in which multiple types of messages MS are transmitted. The controller 40 repeatedly transmits the multiple types of messages MS in accordance with the message table MT.

In the message table MT, the number of types of the messages MS transmitted in a certain cycle is less than or equal to a specified number RN. Further, the message table MT includes information indicating whether a message MS is transferred through end-to-end communication.

In the communication system 20, for example, the controller 40 connected to the first bus 51 repeatedly transmits the multiple types of messages MS via the relay 30 to the controller 40 connected to the second bus 52 in a predetermined cycle.

### Information Processing System of Communication System

As shown in FIG. 3, an information processing system 100 includes the communication system 20 of the vehicle 10 and an information processor 80. The information processing system 100 is configured to set the data length code DLC of the data frame FL in each message MS in the communication system 20.

The information processor 80 processes the message tables MT in the communication system 20 in a centralized manner. In other words, the information processor 80 is configured to set the data length code DLC of the data frame FL in each message MS in the communication system 20.

The information processor 80 is connected to a port of the relay 30 to adjust the message tables MT in the communication system 20. The information processor 80 obtains information related to the data frame FL of a message MS that is relayed by the relay 30.

The information processor 80 includes an execution unit 81 and a memory unit 82. The execution unit 81 is a central processing unit (CPU). The memory unit 82 includes a read-only memory (ROM) and a random-access memory (RAM). The execution unit 81 is capable of executing various programs stored in the memory unit 82. For example, the information processor 80 is used as a development tool for the vehicle 10.

### Method for Processing Information

The memory unit 82 stores an information processing program PR. The information processing program PR is configured to have the information processor 80, which is a computer, perform a method for processing information. The information processing method includes a step of extracting a specific data frame SFL and a step of reconstructing the specific data frame SFL as a new data frame FL having a shorter data length.

The execution unit 81 executes the information processing program PR when an input device (not shown) of the information processor 80 is operated. When the execution unit 81 starts execution of the information processing program PR, the execution unit 81 starts performing the information processing method. First, the execution unit 81 performs step S11.

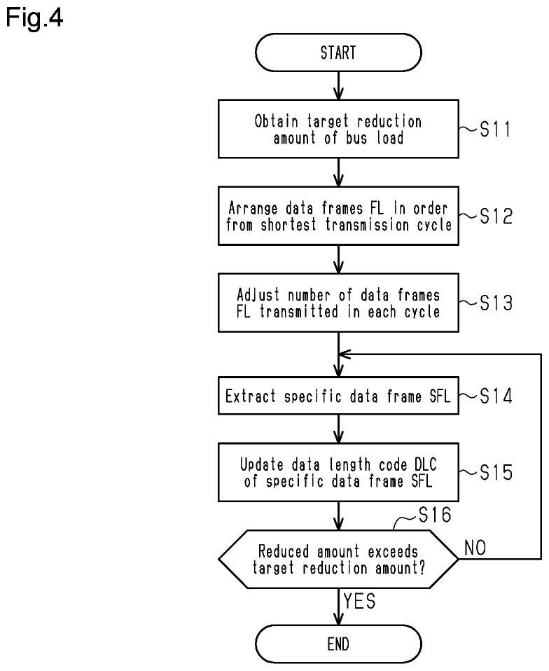

As shown in FIG. 4, in step S11, the execution unit 81 obtains a target reduction amount of the bus load in accordance with a subject message table MT. Specifically, the execution unit 81 simulates a case in which multiple types of messages MS are transmitted in accordance with the present message table MT based on the cycles and the data length codes DLC in the message table MT. The execution unit 81 calculates the bus load when the messages MS transmitted in the hypothetical case flow through the communication buses 50. Then, the execution unit 81 subtracts a predetermined target bus load from the calculated bus load to obtain the target reduction amount of the bus load. Subsequently, the execution unit 81 proceeds to step S12.

In step S12, the execution unit 81 arranges the multiple types of messages MS, transmitted in accordance with the message table MT, in order from those having the shortest transmission cycle. In other words, the execution unit 81 arranges the data frames FL, flowing through the communication buses 50 in accordance with the message table MT, in order from those having the shortest transmission cycle. Then, the execution unit 81 proceeds to step S13.

In step S13, the execution unit 81 adjusts the number of data frames FL transmitted in each cycle. The process of step S13 will be described later. After the number of data frames FL is adjusted for each cycle, the execution unit 81 proceeds to step S14.

In step S14, the execution unit 81 extracts, from the multiple types of data frames FL, a specific data frame SFL having a data field FD that can be shortened based on the types of the data frames FL. The process of step S14 will be described later. After the specific data frame SFL is extracted, the execution unit 81 proceeds to step S15.

In step S15, the execution unit 81 updates the data length code DLC of the specific data frame SFL to indicate a shorter data field FD. In this manner, the execution unit 81 reconstructs the specific data frame SFL as a new data frame FL having a shorter data length. The process of step S15 will be described later. After the data length code DLC of the specific data frame SFL is shortened, the execution unit 81 proceeds to step S16.

In step S16, the execution unit 81 determines whether the reduced amount of the bus load exceeds the target reduction amount. In other words, after the data length code DLC of the specific data frame SFL is updated, the execution unit 81 determines whether a predicted communication load on the communication buses 50 is greater than or equal to a predetermined threshold value. Specifically, the execution unit 81 uses the cycles in the subject message table MT and the data length code DLC of the updated specific data frame SFL to obtain the bus load. Then, the execution unit 81 subtracts the obtained bus load from the initial bus load, which was used to calculate the target bus load reduction amount, and obtains the reduced amount of the bus load. Subsequently, the execution unit 81 compares the obtained reduction amount with the target reduction amount. When the reduced amount of the bus load exceeds the target reduction amount (S16: YES), the execution unit 81 ends processing.

When the reduced amount of the bus load is less than or equal to the target reduction amount (S16: NO), the execution unit 81 returns to step S13. This extracts another specific data frame SFL and shortens the data length code DLC of the extracted specific data frame SFL. The execution unit 81 repeats these processes until the reduced amount of bus load exceeds the target reduction amount.

### Process for Adjusting Number of Data Frames Transmitted in Each Cycle

When the execution unit 81 starts the process for adjusting the number of the data frames FL transmitted in each cycle in step S13, the execution unit 81 starts the process from step S21.

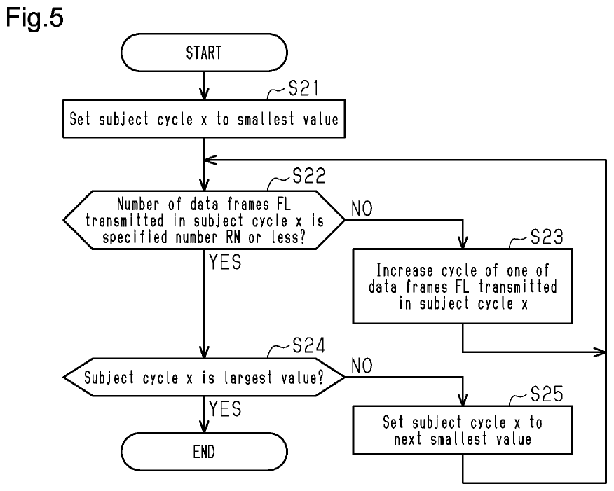

As shown in FIG. 5, in step S21, the execution unit 81 sets a subject cycle x to the smallest value of the cycles. Then, the execution unit 81 proceeds to step S22.

In step S22, the execution unit 81 determines whether the number of data frames FL transmitted in the subject cycle x is less than or equal to the specified number RN. The specified number RN is set in advance to a value less than the maximum number of the data frames FL that can be transmitted in the subject cycle x. For example, after the number of data frames FL has been adjusted for each cycle through the present series of processes, data frames FL transmitted in the subject cycle x may be added in the future. Thus, the specified number RN is set to a value less than the maximum number. When the number of data frames FL transmitted in the subject cycle x is greater than the specified number RN (S22: NO), the execution unit 81 proceeds to step S23.

In step S23, the execution unit 81 adjusts the cycle of one of the data frames transmitted in the subject cycle x. Specifically, the execution unit 81 increases the cycle of one of the data frames FL transmitted in the subject cycle x by one unit. More specifically, the execution unit 81 adds 1 ms to the cycle of the subject data frame FL. That is, the execution unit 81 increases the cycle of one of the data frames FL transmitted in the subject cycle x. This decreases the number of the data frames FL transmitted in the subject cycle x. Then, the execution unit 81 returns to step S22. In other words, the execution unit 81 decreases the number of data frames FL transmitted in the subject cycle x to the specified number RN.

When the number of data frames FL transmitted in the subject cycle x is less than or equal to the specified number RN (S22: YES), the execution unit 81 proceeds to step S24. In step S24, the execution unit 81 determines whether the subject cycle x is the largest value of the cycles. When the subject cycle x is not the largest value of the cycles (S24: NO), the execution unit 81 proceeds to step S25.

In step S25, the execution unit 81 sets the subject cycle x to the next smallest value of the cycles. Specifically, the execution unit 81 sets the subject cycle x to a cycle that is longer than the present subject cycle x by one unit. Then, the execution unit 81 returns to step S22.

When the subject cycle x is the largest value of the cycles (S24: YES), the execution unit 81 ends processing. The execution unit 81 performs steps S22 and S23 on the data frames FL transmitted in each cycle so that the number of data frames FL transmitted in each cycle becomes less than or equal to the specified number RN. This completes the process of step S13 shown in FIG. 1.

### Process for Extracting Specific Data Frame

When the execution unit 81 starts the process for extracting the specific data frame SFL in step S14, the execution unit 81 starts the process from step S31.

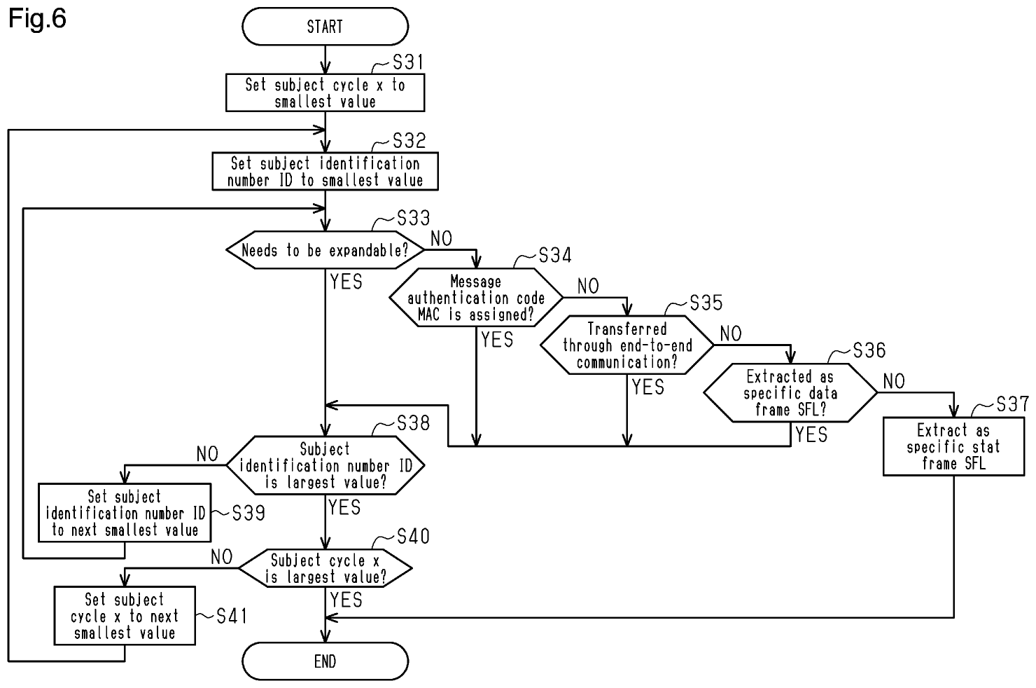

As shown in FIG. 6, in step S31, the execution unit 81 sets the subject cycle x to the smallest value of the cycles. Then, the execution unit 81 proceeds to step S32.

In step S32, the execution unit 81 sets the subject identification number ID to the smallest value. Then, the execution unit 81 proceeds to step S33.

In step S33, the execution unit 81 determines whether a data frame FL having the subject identification number ID and transmitted in the subject cycle x needs to be expandable. Specifically, the execution unit 81 determines whether the data D included in the subject data frame FL requires an expandable data field FD. In the present specification, the phrase “needs to be expandable” refers to a situation in which a data frame FL does not have to entirely accommodate data D presently but has the capacity to accommodate more data D in the future. The data frame FL including the data D that requires an expandable data field FD is defined in accordance with the type of the message MS or tests and simulations conducted in advance. The execution unit 81 determines that the subject data frame FL needs to be expandable when the data frame FL matches a predetermined data frame FL that needs to be expandable. When the execution unit 81 determines that the subject data frame FL does not need to be expandable (S33: NO), the execution unit 81 proceeds to step S34.

In step S34, the execution unit 81 determines whether a message authentication code MAC is assigned to the subject data frame FL. When the message authentication code MAC is not assigned to the subject data frame FL (S34: NO), the execution unit 81 proceeds to step S35.

In step S35, the execution unit 81 determines whether the subject data frame FL is transferred through end-to-end communication. The execution unit 81 determines that the subject data frame FL is transferred through end-to-end communication when the type of the subject data frame FL matches that of a predetermined data frame FL transferred through end-to-end communication. When the subject data frame FL is not transferred through end-to-end communication (S35: NO), the execution unit 81 proceeds to step S36.

In step S36, the execution unit 81 determines whether the subject data frame FL has already been extracted as the specific data frame SFL. When the subject data frame FL has not been extracted as the specific data frame SFL (S36: NO), the execution unit 81 proceeds to step S37.

In step S37, the execution unit 81 extracts the subject data frame FL as the specific data frame SFL. In other words, the execution unit 81 extracts, as the specific data frame SFL, a data frame FL that does not have to be expandable. The execution unit 81 extracts, as the specific data frame SFL, a data frame FL including no message authentication code MAC. The execution unit 81 extracts, as the specific data frame SFL, a data frame FL that is not transferred through end-to-end communication. The execution unit 81 extracts, as the specific data frame SFL, a data frame FL that has not been extracted as the specific data frame SFL. Subsequently, the execution unit 81 ends the process for extracting the specific data frame SFL.

When the subject data frame FL needs to be expandable (S33: YES), the execution unit 81 proceeds to step S38. Further, when a message authentication code MAC is assigned to the subject data frame FL (S34: YES), the execution unit 81 proceeds to step S38. Furthermore, when the subject data frame FL is transferred through end-to-end communication (S35: YES), the execution unit 81 proceeds to step S38. Furthermore, when the subject data frame FL has already been extracted as the specific data frame SFL (S36: YES), the execution unit 81 proceeds to step S38.

In step S38, the execution unit 81 determines whether the subject identification number ID is the largest value. When the subject identification number ID of the data frame FL is not the largest value (S38: NO), the execution unit 81 proceeds to step S39.

In step S39, the execution unit 81 sets the subject identification number ID to the next smallest value. Then, the execution unit 81 returns to step S33. Specifically, the execution unit 81 selects a data frame FL having the smallest identification number ID from the data frames FL that have not undergone steps S33 to S37, and designates the data frame FL as the next subject. Then, the execution unit 81 performs steps S33 to S37 on the subject data frame FL. In this manner, the execution unit 81 performs steps S33 to S37 on each one of the data frames FL, having different identification numbers ID and transmitted in the subject cycle x, in order from those having the smallest identification number ID until the specific data frame SFL is extracted.

When the identification number ID of the subject data frame FL is the largest value (S38: YES), the execution unit 81 proceeds to step S40. In step S40, the execution unit 81 determines whether the subject cycle x is the largest value. When the subject cycle x, in which the subject data frame FL is transmitted, is not the largest value (S40: NO), the execution unit 81 proceeds to step S41.

In step S41, the execution unit 81 sets the subject cycle x to the next smallest value. Then, the execution unit 81 returns to step S32. In this manner, the execution unit 81 selects a data frame FL transmitted in the shortest cycle from the data frames that have not undergone steps S32 to S39, and designates the data frame FL as the next subject. Then, the execution unit 81 performs steps S32 to S39 on the subject data frame FL. Thus, the execution unit 81 extracts the specific data frame SFL as described below. The multiple types of data frames FL include a first data frame FL1 transmitted in a first cycle. Further, the multiple types of data frames FL include a second data frame FL2, differing from the first data frame FL1, transmitted in a second cycle that is longer than the first cycle. In this case, the execution unit 81 extracts the specific data frame SFL from the second data frame FL2 when the specific data frame SFL cannot be extracted from the first data frame FL1. In other words, the execution unit 81 performs steps S33 to S37 on each one of the data frames FL, transmitted in multiple types of cycles, in order from those transmitted in the shortest cycle until the specific data frame FL is extracted.

When the subject cycle x is the largest value (S40: YES), the execution unit 81 does not extract the specific data frame SFL. The execution unit 81 outputs a signal indicating an error to a monitor (not shown), and then ends the process of step S14 shown in FIG. 1.

As shown in FIG. 4, after the specific data frame SFL is extracted in step S14, if the reduced amount of the bus load is less than or equal to the target reduction amount in step S16 (S16: NO), the execution unit 81 performs step S14 again. Through this repetitive operation, the execution unit 81 first extracts the specific data frames SFL from the first data frame FL1 transmitted in a specific the subject cycle x. Further, the execution unit 81 updates the data length code DLC of every one of the specific data frame SFL extracted from the first data frame FL1. Then, if the predicted communication load on the communication buses 50 is still greater than or equal to the threshold value, the execution unit 81 extracts another specific data frame SFL again in step S14. In this case, the subject cycle x in which the newly extracted specific data frame SFL is transmitted is the second cycle, which is longer than that of the first data frame FL1. Specifically, the execution unit 81 extracts the specific data frames SFL from the first data frame FL1, updates the data length codes DLC thereof, and then extracts the specific data frames SFL from the second data frame FL2.

### Process for Updating Data Length Code

When the execution unit 81 starts the process for shortening the data length code DLC of the specific data frame SFL in step S15, the execution unit 81 starts the process from step S51.

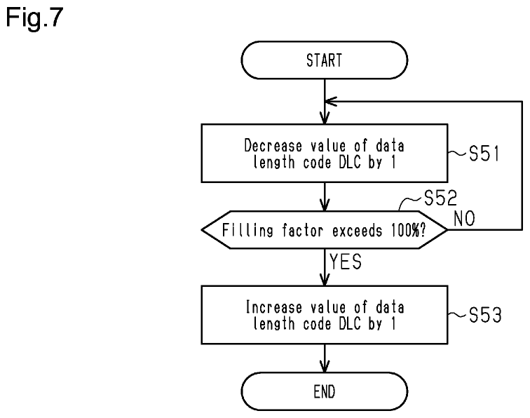

As shown in FIG. 7, in step S51, the execution unit 81 decreases the present value of the data length code DLC of the extracted specific data frame SFL by one. Then, the execution unit 81 proceeds to step S52.

In step S52, the execution unit 81 determines whether the filling factor of the data D in the specific data frame SFL exceeds 100%. The filling factor of the data D is a value obtained by dividing the bit length of the data D by the bit length of the data field FD. That is, the execution unit 81 determines whether the data D fits into the data field FD based on the value of the data length code DLC obtained in step S51.

When the filling factor of the data D in the specific data frame SFL is less than or equal to 100% (S52: NO), the execution unit 81 returns step S51. In other words, the execution unit 81 decreases the data length code DLC of the specific data frame SFL by one until the filling factor exceeds 100%.

When the filling factor of the data D in the specific data frame SFL exceeds 100% (S52: YES), the execution unit 81 proceeds to step S53. In step S53, the execution unit 81 increases the present value of the data length code DLC of the specific data frame SFL. In this manner, the execution unit 81 updates the data length code DLC such that the maximum filling factor of the data D stored in the data field FD does not exceed 100%. This completes the process of step S15 shown in FIG. 1.

### Operation of Present Embodiment

In the above embodiment, the information processor 80 executes the information processing program PR and adjusts the message table MT stored in the controller 40. In this case, the information processor 80 extracts the specific data frame SFL from multiple types of the data frames FL. Then, the information processor 80 reconstructs the specific data frame SFL as a new data frame having a shorter data length by updating the value of the data length code DLC of the specific data frame SFL to indicate a shorter data field FD.

### Advantages of the Embodiment

(1) In the above embodiment, the specific data frame SFL is reconstructed as a new data frame having a shorter data length. This decreases the total volume of the messages MS relayed by the relay 30 when the number of messages MS is the same. Thus, when designing the data frame FL transferred through the communication system 20, the designed data frame FL allows for more efficient communication.

(2) In the above embodiment, the execution unit 81 updates the data length code DLC included in the specific data frame SFL as follows. The execution unit 81 updates the data length code DLC such that the filling factor of the data D stored in the data field FD does not exceed 100%. This minimizes the data length of the message MS while ensuring the size of the data field FD for storage of the data D included in the specific data frame SFL.

(3) In the above embodiment, the execution unit 81 extracts, as the specific data frame SFL, a data frame FL including no message authentication code MAC. The data length of the data frame FL including the message authentication code MAC is used for message authentication. Accordingly, if the data length of the data frame FL including the message authentication code MAC is shortened, the message authentication may not be successful. The above embodiment avoids unsuccessful message authentication.

(4) In the above embodiment, the execution unit 81 extracts, as the specific data frame SFL, a data frame FL that is not transferred through end-to-end communication. The data length of the data frame FL transferred through end-to-end communication is used by a device that transmits the data frame FL. Accordingly, if the data length of the data frame FL transferred through end-to-end communication is shortened, the transmission process may fail. The above embodiment avoids failures in processing of the data frame FL transferred through end-to-end communication.

(5) In the above embodiment, the execution unit 81 extracts the specific data frame SFL from the second data frame FL2 when the specific data frame SFL cannot be extracted from the first data frame FL1. Specifically, the execution unit 81 extracts the specific data frame SFL from the first data frame FL1, which are transmitted in the relatively short first cycle, and then extracts the specific data frame SFL from the second data frame FL2, which are transmitted in the relatively long second cycle. Since transmission of the data frames FL is repeated more frequently in a shorter cycle, the communication load is more readily reduced by shortening the data length of the data frames transmitted in a shorter cycle. In this manner, the data frames FL that will obtain greater effects are given priority when the specific data frames SFL are selected.

(6) In the above embodiment, the execution unit 81 extracts the specific data frames SFL from the first data frame FL1. Also, the execution unit 81 updates the data length code DLC of every one of the specific data frames SFL extracted from the first data frame FL1. If the predicted communication load on the communication buses 50 is still greater than or equal to the threshold value, the execution unit 81 extracts the specific data frames FL from the second data frame FL2. In other words, if the communication load on the communication buses 50 is still large even after shortening the data length of each data frame FL transmitted in the shorter cycle, the execution unit 81 attempts to determine whether the data frames FL transmitted in the longer cycle can be designated as the specific data frames SFL. This increases the possibility that the execution unit 81 decreases the communication load on the communication buses 50 to be less than the threshold value.

### OTHER EMBODIMENTS

The above embodiment may be modified as follows. The above embodiment and the following modifications can be combined as long as the combined modifications remain technically consistent with each other.

The configuration of the communication system 20 is not limited to that described in the above embodiment. For example, the communication system 20 may include three or more communication buses 50.

The information processor 80 may be processing circuitry including one or more processors that run on a computer program (software) to execute various processes. Alternatively, the information processor 80 may be processing circuitry including one or more exclusive hardware circuits such as an application specific integrated circuit (ASIC) to execute at least part of various processes. Further, the information processor 80 may be processing circuitry including a combination of the above. A processor is, for example, a CPU. A memory includes a RAM, a ROM, and the like. The memory stores program codes or commands that are configured to have the CPU execute a process. A non-transitory computer-readable storage medium, such as a ROM, may be any available medium that is accessible by a versatile or dedicated computer. The same applies to the relay 30 and the controllers 40.

The method for updating the data length code DLC of the specific data frame SFL is not limited to that described in the above embodiment. For example, the information processor 80 may update the data length code DLC only in step S51, and steps S52 and S53 may be omitted. Further, in step S51, the information processor 80 may decrease the data length code DLC by two or more.

In the above embodiment, step S33 may be omitted. Specifically, the specific data frame SFL may be extracted regardless of the expandability of the data frame FL.

In the above embodiment, step S34 may be omitted. Specifically, the specific data frame SFL may be extracted regardless of message authentication of the data frame FL.

In the above embodiment, step S35 may be omitted. Specifically, the specific data frame SFL may be extracted regardless of whether the data frame FL is transferred through end-to-end communication.

The method for selecting the specific data frame SFL from the multiple types of data frames FL is not limited to that described in the above embodiment. The specific data frame SFL may only extracted based on the type of the data frame FL. For example, the data frames FL transmitted in the shortest cycle may be selected from the multiple types of data frames FL, and then one data frame FL may be randomly extracted, as the specific data frame SFL, from the selected data frames FL.

When the specific data frame SFL is extracted a number of times, a specific data frame SFL may be extracted from the second data frame FL2 before extracting every specific data frame SFL from the first data frame FL1.

In the above embodiment, the specific data frame SFL may be extracted regardless of the cycle in which the specific data frame SFL is transmitted. For example, if each data frame FL has a different identification number ID regardless of the cycle, steps S33 to S37 may be performed on the data frames SFL in order from those having the smallest identification number ID.

In the above embodiment, steps S12 and S13 may be omitted. The information processor 80 may only extract the specific data frame SFL and update the data length code DLC of the specific data frame SFL in accordance with the message table MT including the cycle and the identification number ID assigned in advance.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processor, comprising:
processing circuitry, wherein:
the processing circuitry is configured to extract, from multiple types of data frames transmitted through a communication bus, a specific data frame having a data length that can be shortened based on data frame type, each of the data frames including a data field and a data length code indicating a data length of the data field; and
the processing circuitry is configured to reconstruct the specific data frame as a new data frame having a shorter data length by updating the data length code included in the specific data frame to indicate the shorter data length.

2. The information processor according to claim 1, wherein the processing circuitry is configured to update the data length code included in the specific data frame such that a maximum filling factor of data stored in the data field does not exceed 100%.

3. The information processor according to claim 1, wherein the processing circuitry is configured to extract, as the specific data frame, a data frame including no message authentication code.

4. The information processor according to claim 1, wherein the processing circuitry is configured to extract, as the specific data frame, a data frame that is not transferred through end-to-end communication.

5. The information processor according to claim 1, wherein:
the multiple types of the data frames include
a first data frame transmitted in a first cycle, and
a second data frame, differing from the first data frame, transmitted in a second cycle that is longer than the first cycle; and
the processing circuitry is configured to extract the specific data frame from the second data frame when the specific data frame cannot be extracted from the first data frame.

6. The information processor according to claim 5, wherein:
when a predicted communication load on the communication bus is greater than or equal to a threshold value after the processing circuitry extracts the specific data frame from the first data frame and updates the data length code of every one of the specific data frame extracted from the first data frame, the processing circuitry is configured to extract the specific data frame from the second data frame.

7. A method for processing information, the method comprising:
extracting, from multiple types of data frames transmitted through a communication bus, a specific data frame having a data length that can be shortened based on data frame type with a computer, wherein each of the data frames includes a data field and a data length code indicating a data length of the data field; and
reconstructing the specific data frame as a new data frame having a shorter data length by updating the data length code included in the specific data frame to indicate the shorter data length with the computer.

8. A non-transitory computer-readable storage medium storing an information processing program, wherein the information processing program causes a computer to:
extract, from multiple types of data frames transmitted through a communication bus, a specific data frame having a data length that can be shortened based on data frame type, each of the data frames including a data field and a data length code indicating a data length of the data field; and
reconstruct the specific data frame as a new data frame having a shorter data length by updating the data length code included in the specific data frame to indicate the shorter data length.
